(19) United States
(12) Patent Application Publication
(10) Pub. No.: US 2026/0043585 A1
(43) Pub. Date: Feb. 12, 2026

(54) PARAMETER-SETTING PROGRAM AND COMBUSTION SYSTEM

(71) Applicant: RINNAI CORPORATION, Nagoya-shi, Aichi (JP)

(72) Inventor: Takuya Miura, Aichi (JP)

(21) Appl. No.: 19/099,381

(22) PCT Filed: Oct. 5, 2023
(86) PCT No.: PCT/JP2023/036414

§ 371 Date: Jan. 28, 2025

(30) Foreign Application Priority Data
Jan. 11, 2023 (JP) 2023-002613

(51) Int. Cl. F24H 15/281; F24H 15/464

(52) U.S. Cl. CPC F24H 15/281; F24H 15/464

(57) ABSTRACT

A parameter-setting program operates on an information terminal 50 that may perform wireless communication with a combustion device 10. The parameter-setting program may cause the information terminal 50 to execute: processing to cause, when a parameter is to be set for one combustion device 10, the information terminal 50 or an external storage device to store the parameter inputted into the information terminal 50; processing to cause, when, after the storing, the parameter is to be set for another combustion device, the information terminal 50 to display an option to instruct the information terminal 50 to write the stored parameter into the other combustion device 10; and processing to write the stored parameter into the other combustion device 10 when the option is selected.

### TECHNICAL FIELD

The present invention relates to a parameter-setting program for a combustion device and to a combustion system.

### BACKGROUND ART

With regard to, for example, a water heating device that comprises a combustion device, conventional techniques are known for setting parameters in a control portion of the water heating device, where the parameters (gas type, exhaust variation, number, bath type, brand name, and the like) are necessary to perform operation control and the like for the combustion device, as seen in Patent Literature 1.

With this technique, once values are set for some parameters, the model of the water heating device is identified based on these values, and values for the other parameters are set automatically according to the identified model.

### CITATION LIST

### Patent Literature

### Patent Literature 1

Japanese Patent Laid-Open No. 2014-185828

### SUMMARY OF INVENTION

### Technical Problem

Many combustion devices (such as water heating devices) with the same specifications are often installed in a building, such as an apartment building. In this case, when parameters are set for each of the combustion devices in a manner as described in Patent Literature 1, the task of inputting the values for those parameters that are necessary to identify the model needs to be repeated for each of the many combustion devices, resulting in poor work efficiency. Especially when the number of parameters required to identify the model is relatively large, it takes significant time and effort to complete the task of setting the parameters for the many combustion devices. In addition, incorrect input of parameters is likely to occur for some of the combustion devices.

The present invention has been made in view of the background described above and has an object of providing a parameter-setting program and a combustion system that allow efficient performance of the task of setting parameters for a plurality of combustion devices, where the parameters are necessary for the operation of the combustion devices.

### Solution to Problem

To achieve the object described above, a parameter-setting program according to the present invention is a parameter-setting program that operates on an information terminal capable of performing wireless communication with a combustion device, the parameter-setting program being configured to be capable of causing the information terminal to execute:
processing to cause the information terminal to display a parameter input screen when a combustion device has started wireless communication with the information terminal and a parameter associated with an operation of the combustion device has not been set, the parameter input screen being a screen for inputting a set value for the parameter;
processing to write a parameter into the combustion device that is in the wireless communication with the information terminal, the parameter having been input into the information terminal in accordance with content displayed on the parameter input screen;
processing to cause the information terminal or an external storage device capable of communicating with the information terminal, to store the inputted parameter;
processing to cause, when, after the storing, another combustion device has started wireless communication with the information terminal and a parameter has not been set in the other combustion device, the information terminal to display an option to instruct the information terminal to write the stored set value for the parameter into the other combustion device; and
processing to write the stored set value for the parameter into the other combustion device when the option is selected.

The parameter-setting program according to the present invention allows a parameter that has been set in one combustion device to be stored and held in the information terminal or the external storage device. The parameter-setting program also allows the set value for the parameter that has been stored and held, to be directly written into another combustion device. Thus, for the other combustion device, the task of inputting a set value for the parameter into the information terminal can be omitted.

Therefore, the parameter-setting program according to the present invention allows efficient performance of the task of setting a parameter for a plurality of combustion devices, where the parameter is necessary for the operation of the plurality of combustion devices.

With the parameter-setting program, the parameter can comprise at least one of a set value related to exhaust resistance of an exhaust gas passageway connected to the combustion devices, and a set value related to a type of fuel gas to be supplied to the combustion devices.

A plurality of combustion devices installed in an apartment building or the like often uses the same configuration for the exhaust gas passageways or the same type of fuel gas to be used. Thus, the set value related to the exhaust resistance for the exhaust gas passageway or the type of fuel gas serves as a parameter common to each of the plurality of combustion devices installed in the apartment building or the like.

Therefore, by using the parameter-setting program according to the present invention for a plurality of combustion devices installed in an apartment building or the like, a parameter can be set efficiently for the plurality of combustion devices.

Furthermore, the combustion system according to the present invention is a combustion system comprising: a combustion device; and an information terminal capable of performing wireless communication with the combustion device,
wherein the information terminal is configured to be capable of executing: processing to display a parameter input screen when a combustion device has started wireless communication with the information terminal and a parameter associated with an operation of the combustion device has not been set, the parameter input screen being a screen for inputting a set value for the parameter; processing to transmit a set value for the parameter to the combustion device that is in the wireless communication with the information terminal, the set value for the parameter having been input into the information terminal in accordance with content displayed on the parameter input screen;
processing to store the inputted parameter in the information terminal or an external storage device capable of communicating with the information terminal; processing to display, when, after the storing, another combustion device has newly started wireless communication with the information terminal and a parameter has not been set in the other combustion device, an option to instruct the information terminal to write the stored set value for the parameter into the other combustion device; and processing to transmit the stored set value for the parameter to the other combustion device, when the option is selected, and
each of the combustion devices is configured to store and hold the set value for the parameter received from the information terminal through the wireless communication with the information terminal.

With the combustion system according to the present invention, after a set value for a parameter set for one combustion device is stored in the information terminal or the external storage device, the task of inputting the set value for the parameter into the information terminal for other combustion devices can be omitted, as with the parameter-setting program.

Therefore, the combustion system according to the present invention allows efficient performance of the task of setting a parameter for a plurality of combustion devices, where the parameter is necessary for the operation of the plurality of combustion devices.

### BRIEF DESCRIPTION OF DRAWINGS

FIG. 1 is a diagram showing a configuration of a combustion system according to an embodiment of the present invention.

FIG. 2 is a flowchart showing processing related to setting of a parameter.

FIG. 3 is a flowchart showing processing related to setting of a parameter.

### DESCRIPTION OF EMBODIMENT

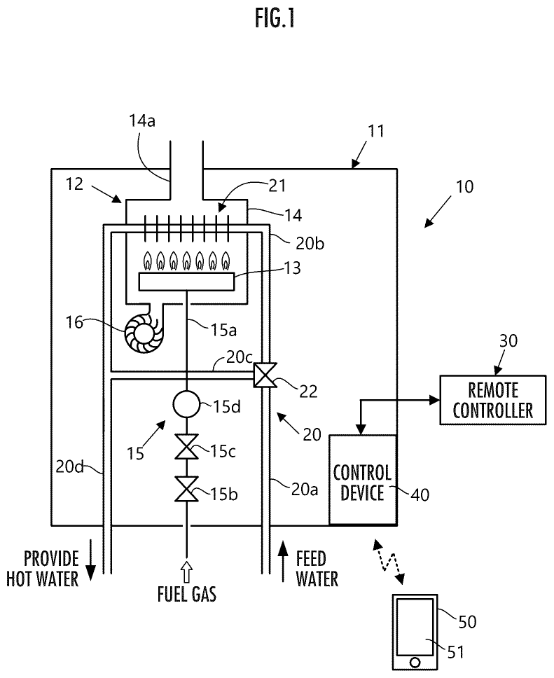

An embodiment of the present invention is described below with reference to FIGS. 1 to 3. Referring to FIG. 1, a combustion system 1 according to the present embodiment comprises: a water heating device 10 that has a function of a combustion device; and an information terminal 50 that may perform wireless communication with the water heating device 10.

The water heating device 10 comprises: a heat source device 11 that may perform a hot water supply operation, which heats up water-to-be-heated and supplies hot water; and a remote controller 30 for operating the heat source device 11. The heat source device 11 comprises a combustion device main body 12 and a water passageway 20 through which water-to-be-heated flows.

The combustion device main body 12 comprises: a burner 13; a burner housing 14 that houses the burner 13 inside (a combustion chamber); a fuel supply device 15 that supplies fuel (a fuel gas in the present embodiment) to the burner 13 through a fuel supply passageway 15a; a combustion fan 16 that supplies combustion air to the burner 13; and an ignition device (not shown). The burner housing 14 is connected to an exhaust gas passageway 14a that discharges to the outside a combustion exhaust gas generated by a combustion operation of the burner 13.

The fuel supply device 15 comprises: two on-off valves 15b and 15c (solenoid valves, for example) for opening and closing the fuel supply passageway 15a; and a fuel regulating valve 15d (a proportional valve, for example) for regulating the quantity of fuel supply to the burner 13. A fuel gas can be supplied to the burner 13 by controlling the opening of the on-off valves 15b and 15c.

The burner 13 can be ignited to start the combustion operation by operating the ignition device while the fuel gas is supplied to the burner 13 by the fuel supply device 15 and combustion air is supplied to the burner 13 by the combustion fan 16. Furthermore, during the combustion operation of the burner 13, a quantity of combustion of the burner 13 can be controlled by regulating the quantity of fuel supply and a quantity of combustion air supply to the burner 13 through the fuel regulating valve 15d and the combustion fan 16, respectively.

The burner housing 14 comprises a heat exchanger 21 in such a way that the heat exchanger 21 can be heated by the combustion operation of the burner 13. The water passageway 20 of the heat source device 11 is configured to allow water-to-be-heated, which is supplied from a water supply source (not shown), to flow from a water supply pathway 20a through a flow pathway 20b, which passes through the heat exchanger 21, and a bypass pathway 20c, which extends in parallel with the flow pathway 20b, to a hot water pathway 20d, and then from the hot water pathway 20d to a hot water supply target portion (not shown), such as a hot water faucet and a shower. The ratio (the bypass ratio as may be generally called) between the water flow rate of the bypass pathway 20c and the water flow rate of the heat exchanger 21 can be adjusted by, for example, controlling the operation of a valve device 22, such as an electric three-way valve, attached to a joint between the water supply pathway 20a and the bypass pathway 20c.

The heat source device 11 comprises a control device 40 having a function of controlling the operation of the heat source device 11. The control device 40 is connected to the remote controller 30 through a wired connection such that the control device 40 may communicate with the remote controller 30. The remote controller 30 allows manipulation thereon to turn ON or OFF the operation of the heat source device 11 or to set a target value for the temperature of hot water. The remote controller 30 can also display information such as an operation status of the heat source device 11.

The control device 40 is configured using one or more electronic circuit units that include: a processor (not shown), such as a microcomputer; a memory, such as RAM and ROM; and an interface circuit. The control device 40 can control the operation of the heat source device 11 (such as controlling the combustion operation of the burner 13) through functions achieved by a hardware configuration and programs (software configuration) implemented.

The control device 40 also includes a wireless communication module (not shown), such as Bluetooth (registered trademark), Wi-Fi (registered trademark), and infrared communications and can perform wireless communication with the information terminal 50 through the wireless communication module.

The information terminal 50 is a communication terminal for use by a contractor, such as an installer of the water heating device 10 or a service provider who performs maintenance, inspection, and the like of the water heating device 10, and comprises a smartphone, a tablet terminal, a dedicated terminal, or the like. The information terminal 50 has an application (hereinafter referred to as parameter-setting application) pre-installed therein for setting, checking, or the like of a parameter for the control device 40 of each water heating device 10, where the parameter is associated with heat source devices of various types of water heating device, such as the heat source device 11 of the water heating device 10. The parameter-setting application corresponds to an example of the parameter-setting program according to the present invention.

The parameter described above is data necessary for the operation of the water heating device 10 and includes, for example, the type of fuel gas, a quantity of extension of the exhaust gas passageway 14a relative to a standard length, the upper limit value of the target hot water temperature. The quantity of extension of the exhaust gas passageway 14a corresponds to a set value related to exhaust resistance of the exhaust gas passageway 14a. A set value related to the exhaust resistance is not limited to the quantity of extension of the exhaust gas passageway 14a and may include, for example, a cross-sectional area of the exhaust gas passageway 14a and the like.

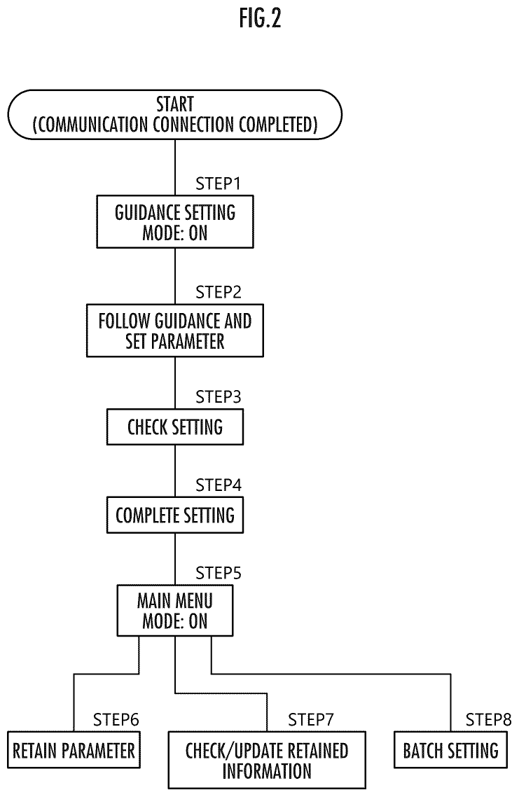

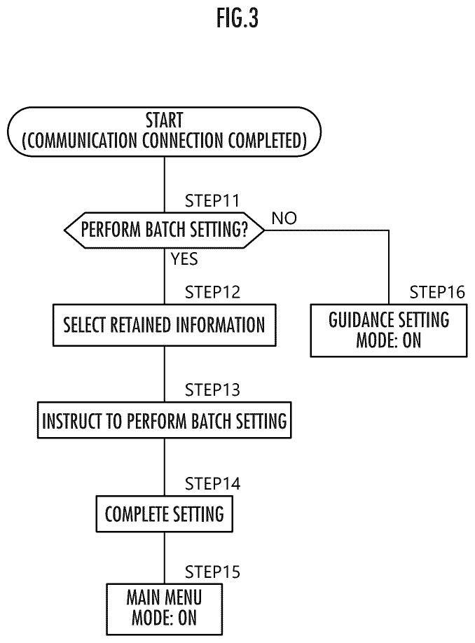

A specific description is provided next, with reference to FIGS. 2 and 3, for a task performed by a contractor using the information terminal 50 when, for example, the water heating device 10 has been installed for each apartment in an apartment building or the like. In this description, an example is used where water heating devices 10 of the same model have been installed for the apartments of the apartment building, and parameters are to be set in the water heating device 10 for each apartment using the information terminal 50. Parameters have not been set in the control device 40 of each of the water heating devices 10.

In the description below, a water heating device 10 for which a parameter is to be set is referred to as a water heating device 10 of interest, and the control device 40 of the water heating device 10 of interest is referred to as a control device 40 of interest.

With reference to FIG. 2, processing is described below to set a parameter for any first water heating device 10 among a plurality of water heating devices 10. In this case, communication connection (pairing, for example) is performed between a control device 40 of a water heating device 10 of interest, which is the first water heating device 10, and the information terminal 50. When the communication connection is completed, wireless communication is started between the control device 40 of interest and the information terminal 50. When the wireless communication is started and if a parameter has not been set in the control device 40 of interest, the parameter-setting application of the information terminal 50 starts (turns ON) a guidance setting mode at Step 1.

The guidance setting mode is a mode in which guidance in setting a parameter is given to a user of the information terminal 50 while the parameter-setting application displays a parameter input screen, which is a screen for inputting a set value for a parameter, on a display 51 of the information terminal 50. In this way, the guidance setting mode allows the user to perform manipulation to input a set value for the parameter.

When the guidance setting mode is started, the user follows the guidance to set a plurality of parameters (performs manipulation to input set values for the parameters into the information terminal 50) at Step 2.

When the user finishes the manipulation to input the set values for the parameters, the user performs checking (setting checking) of the set values for the parameters that have been input at Step 3. The parameter-setting application displays the set value input by the user for each parameter on the display 51 of the information terminal 50.

Subsequently, at Step 4, the user performs manipulation on the information terminal 50 to complete the setting of the parameters (manipulation to confirm that the set values for the parameters have been checked). In response to that, the parameter-setting application transmits the set values for the parameters input by the user from the information terminal 50 to the control device 40 of interest. The control device 40 of interest stores and holds the received set values for the parameters in the memory. In this way, the set values for the parameters that have been input into the information terminal 50 are written into the control device 40 of interest.

The parameter-setting application starts (turns ON) a main menu mode at Step 5. In the main menu mode, the user can perform: manipulation to retain (store and hold) the inputted parameters in the information terminal 50 (Step 6); manipulation to check or update the set values for the parameters retained in the information terminal 50 (Step 7); or manipulation to perform batch setting of the set values for the parameters retained in the information terminal 50 for a control device 40 of a water heating device 10 of interest (Step 8).

The user who has set the parameters into the control device 40 of the first water heating device 10, which is the water heating device 10 of interest, using the guidance setting mode performs the manipulation described above for Step 6. In this way, the set values for all the parameters set in the control device 40 of the first water heating device 10 are stored and held in a nonvolatile memory, such as an EEPROM, in the information terminal 50. At Step 6, the user can add identification information, such as a name, to the set of set values for the parameters to be retained, and the set values for the parameters together with the identification information are stored and held.

If the information terminal 50 can communicate with an external storage device, such as an external server, through an external network such as the Internet, the set values for the parameters and the identification information can be retained (stored and held) in the external storage device.

Processing is described below, with reference to FIG. 3, to set a parameter for another water heating device 10, which is different from the first water heating device 10 described above. In this case, communication connection (pairing, for example) is performed between a control device 40 of a water heating device 10 of interest, which is the other water heating device 10, and the information terminal 50. When the communication connection is completed, wireless communication is started between the control device 40 of interest and the information terminal 50. When the wireless communication is started and if a parameter has not been set in the control device 40 of interest, the parameter-setting application of the information terminal 50 displays, at Step 11, a screen on the display 51 of the information terminal 50, where the screen allows the user to select whether to perform batch setting of parameters into the control device 40 of interest.

As used herein, the batch setting is processing to write a set of set values for the parameters into the control device 40 of interest in a collective manner, where the set of set values for the parameters is retained in the information terminal 50 (or the external storage device).

If the user selects at Step 11 to perform the batch setting, the user performs at Step 12 manipulation on the information terminal 50 to select the retained information (the set of set values for the parameters) on the basis of the identification information, where the retained information being the retained information for which the user wishes to perform the batch setting.

At Step 13, the user instructs the information terminal 50 to perform the batch setting of the selected set of set values for the parameters into the control device 40 of interest. At Step 14, the user performs manipulation on the information terminal 50 to complete the setting of parameters. In response to that, the parameter-setting application transmits the selected set of set values for the parameters from the information terminal 50 to the control device 40 of interest. The control device 40 of interest stores and holds the received set of set values for the parameters in the memory thereof. In this way, the batch setting of the parameters is completed in the control device 40 of interest.

When the batch setting of the parameters is completed, the parameter-setting application starts the main menu mode at Step 15. Said main menu mode is the same as the main menu mode started at Step 5.

If at Step 11 the user does not select to perform the batch setting, the parameter-setting application starts the guidance setting mode at Step 16. Said guidance setting mode is the same as the guidance setting mode started at Step 1. Thus, a parameter can be set in a control device 40 of another water heating device 10, which is other than the first water heating device 10, using the guidance setting mode.

To add more information, when a parameter has been already set in a control device 40 of a water heating device 10, and communication connection is performed between the control device 40 and the information terminal 50, the parameter-setting application of the information terminal 50 starts the main menu mode.

If, at this point, there is a retained set of set values for the parameters available, the batch setting of the set values for the parameters can be performed, at Step 8 shown in FIG. 2, into the control device 40 of the water heating device 10 (that is, the control device 40 that has performed the communication connection with the information terminal 50), as with the processing described in Steps 12 to 14. In this way, the set values for the parameters stored and held in the control device 40 can be updated quickly.

In an embodiment described above, when parameters are to be set in a plurality of water heating device 10 installed in an apartment building or the like, parameters can be set in a second water heating device 10 and subsequent water heating devices 10 through the batch setting; thus, parameters can be set in the plurality of water heating devices 10 efficiently.

The present invention is not limited to the embodiment described above. For example, the combustion device according to the present invention is not limited to those that use a fuel gas as the fuel but may be those that use liquid fuel, such as kerosene. Furthermore, the combustion device is not limited to the water heating device and may be a combustion type warm air heater, a combustion type clothes dryer, a combustion type bathroom heater, and the like.

### REFERENCE SIGNS LIST

10 water heating device (combustion device)
50 information terminal

1. A parameter-setting program that operates on an information terminal capable of performing wireless communication with a combustion device, the parameter-setting program being configured to be capable of causing the information terminal to execute:
processing to cause the information terminal to display a parameter input screen when a combustion device has started wireless communication with the information terminal and a parameter associated with an operation of the combustion device has not been set, the parameter input screen being a screen for inputting a set value for the parameter;
processing to write a parameter into the combustion device that is in the wireless communication with the information terminal, the parameter having been input into the information terminal in accordance with content displayed on the parameter input screen;
processing to cause the information terminal or an external storage device capable of communicating with the information terminal, to store the inputted parameter;
processing to cause, when, after the storing, another combustion device has started wireless communication with the information terminal and a parameter has not been set in the another combustion device, the information terminal to display an option to instruct the information terminal to write the stored set value for the parameter into the another combustion device; and
processing to write the stored set value for the parameter into the another combustion device when the option is selected.

2. The parameter-setting program according to claim 1,
wherein the parameter comprises at least one of a set value related to exhaust resistance of an exhaust gas passageway connected to the combustion devices, and a set value related to a type of fuel gas to be supplied to the combustion devices.

3. A combustion system comprising: a combustion device; and an information terminal capable of performing wireless communication with the combustion device,
wherein the information terminal is configured to be capable of executing: processing to display a parameter input screen when a combustion device has started wireless communication with the information terminal and a parameter associated with an operation of the combustion device has not been set, the parameter input screen being a screen for inputting a set value for the parameter; processing to transmit a set value for the parameter to the combustion device that is in the wireless communication with the information terminal, the set value for the parameter having been input into the information terminal in accordance with content displayed on the parameter input screen; processing to store the inputted parameter in the information terminal or an external storage device capable of communicating with the information terminal; processing to display, when, after the storing, another combustion device has newly started wireless communication with the information terminal and a parameter has not been set in the another combustion device, an option to instruct the information terminal to write the stored set value for the parameter into the another combustion device; and processing to transmit the stored set value for the parameter to the another combustion device, when the option is selected, and
each of the combustion devices is configured to store and hold the set value for the parameter received from the information terminal through the wireless communication with the information terminal.
